(19) United States
(12) Patent Application Publication
(10) Pub. No.: US 2008/0312390 A1
(43) Pub. Date: Dec. 18, 2008

(54) Process for preparation of polyolefin alloy

(75) Inventors: Jinyong Dong, Beijing (CN); Bochao Zhu, Beijing (CN); Zhichao Han, Beijing (CN); Changjun Zhang, Beijing (CN); Hui Niu, Beijing (CN); Shaoyi Wei, Beijing (CN); Jiguang Liu, Beijing (CN); Peihong Yao, Beijing (CN); Hongying Wang, Beijing (CN); Xiaojun Li, Beijing (CN); Dujin Wang, Beijing (CN); Pingsheng Zhang, Beijing (CN); Yajie Zhu, Beijing (CN); Junji Jia, Beijing (CN); Chunbo Huang, Beijing (CN)

Correspondence Address: David Silverstein;Andover-IP-Law, Suite 300, 44 Park Street, Andover, MA, 01810, US

(73) Assignees: Petrochina Company Limited; Institute of Chemistry, Chinese Academy of Sciences

(21) Appl. No.: 11/818,480

(22) Filed: Jun. 14, 2007

(51) Int. Cl. C08F 4/64; C08F 2/00; C08F 4/68; C08F 4/52

(52) U.S. Cl. 526/116; 526/89; 526/185

(57) ABSTRACT

A process for preparing polypropylene compositions having high impact strength at low temperatures is disclosed in which the reaction is catalyzed by Ziegler-Natta/metallocene hybrid catalysts by the in-situ polymerization of one or more olefins of the formula CH₂═CHR, in which R is hydrogen or an alkyl, cycloalkyl or aryl group having from 1 to 10 carbon atoms, and more specifically comprises preparing an olefin polymer by Ziegler-Natta catalyst components of the titanium or vanadium/metallocene hybrid catalysts while the metallocene components are inactivated beforehand by catalyst inactivators; and polymerizing one or more olefins in the presence of the above olefin polymer, followed by a reactivation of the metallocene components.

### FIELD OF THE INVENTION

The present invention relates to a process for preparation of polyolefin alloy, in particular, to a process for preparation of polypropylene alloy.

### BACKGROUND OF THE INVENTION

As is known, the isotactic polypropylene is endowed with an exceptional combination of excellent properties that are suitable for a very great number of uses, including appliances at high temperatures; however, it exhibits the drawback of insufficient impact strength at relatively low temperatures. Attempts were made to obviate such drawback, without substantially adversely affecting other desirable properties, either by properly modifying the synthesis process or by blending the material with rubbers. The modifications to the synthesis process essentially consist in introducing one or more steps of copolymerization of olefins into the propylene stereoregular homopolymerization process, for example, using ethylene-propylene mixtures. The impact strength properties at low temperatures of the isotactic polypropylene can also be improved by adding rubbers, in particular ethylene-propylene rubbers. According to U.S. Pat. No. 3,627,852, which is incorporated herein by reference, it is necessary to incorporate relatively large amounts of ethylene-propylene rubber in order to achieve a significant improvement in the final product. The function of the copolymer seems to be that of absorbing, at least partially, the impact energy in the area of graft and propagation of a fracture, with consequent improvement of the impact strength of the system. However, the impact strength properties of a polypropylene modified with an amorphous ethylene-propylene copolymer substantially depend on the amount and quality of the copolymer.

Multistage processes for the polymerization of olefins, carried out in two or more reactors, are known from the prior arts and are of particular interest in industrial practice. By independently varying, in any reactors, process parameters such as temperature, pressure, type and concentration of monomers, and concentration of hydrogen or other molecular weight regulators, much greater flexibility in controlling the composition and properties of the end product is provided than with the single-stage processes. Multistage processes are generally carried out using the same catalyst in the various stages/reactors: the product obtained in one reactor is discharged and sent directly to the next stage/reactor without altering the nature of the catalyst.

Multistage processes are used in the preparation of high-impact propylene copolymers by sequential polymerization of propylene and mixtures of propylene with ethylene. In a first stage, propylene is homopolymerized or copolymerized with smaller proportions of ethylene and/or olefins having 4-10 carbon atoms, obtaining a stereoregular polymer; in a second stage, mixtures of ethylene and propylene are polymerized in the presence of the polymer including the catalyst that is obtained in the first stage, obtaining polypropylene compositions having improved impact strength.

Processes of this type are described, for example, in U.S. Pat. No.4,521,566, which is incorporated herein by reference. In said patent, polypropylene compositions having high impact strength are prepared in a multistage process that comprises at least one stage of homopolymerization of propylene and at least one stage of polymerization of ethylene/propylene mixtures in the presence, in both stages, of a catalyst comprising a compound of titanium or vanadium supported on a magnesium halide in active form.

European Patent Application EP-A-433989, which is incorporated herein by reference, describes a process for preparing a polypropylene composition containing 20 to 99% by weight of a crystalline (co)polymer, at least 95% by weight of propylene units, 1 to 80% by weight of a noncrystalline ethylene/propylene copolymer, and 20 to 90% by weight of ethylene units. The process is carried out in 2 stages: in liquid propylene in a first stage, the crystalline propylene (co)polymer is produced; and, in hydrocarbon solvent in a second stage, the non-crystalline ethylene/propylene copolymer is produced. The same catalyst consisting of a chiral metallocene and an aluminoxane is used in both stages.

European Patent Application EP-A-433990, which is incorporated herein by reference, describes a process in two stages for the preparation of a propylene-based polymer composition similar to those described in EP-A-433989, in which the crystalline propylene (co)polymer is produced in the first stage by polymerization in liquid propylene, and the noncrystalline ethylene/propylene copolymer is produced in the second stage by gas-phase polymerization. Also in this case, the same catalyst consisting of a chiral metallocene and an aluminoxane is used in both reactors.

German Patent Application DE 4130429, which is incorporated herein by reference, describes a multistage process for the production of block copolymers, accomplished entirely in the gas phase. In a first stage there is production of a matrix consisting of a homo or copolymer of propylene in an amount of between 45 and 95% by weight based on the total product; in a second stage, polymerization is carried out in the presence of both the polypropylene matrix previously produced and the catalyst used therein, thereby producing an ethylene/α-olefin copolymer containing 0.1 to 79.9% by weight of ethylene units in an amount of between 5 and 55% by weight based on the total product. In both stages, polymerization is carried out in the gas phase by using the same metallocene catalyst.

The processes in the prior art have various limitations, one of which derives from the fact that the same catalyst is used in the different process stages and therefore the characteristics of the products obtained in the individual stages are not always optimum. For example, in the case of heterophase copolymers prepared in multistage processes using titanium catalysts, the properties of the rubbery copolymer produced in the second stage are poor. In fact, it is known that titanium catalysts produce ethylene/propylene copolymers containing relatively long sequences of the same monomer unit, and consequently the elastomeric properties of the product are also poor.

Processes in several stages catalyzed by hybrid catalysts have a lot of applications, for example, in the preparation of olefin (co)polymers with broad molecular weight distribution (MWD), by producing polymer species with different molecular weight in the various reactors. Both the molecular weight in each reactor and also the range of the MWD of the final product are generally controlled by using different concentrations of a molecular weight regulator which is preferably hydrogen.

U.S. Pat. No. 5,648,422, which is incorporated herein by reference, describes a multistage process for the production of olefin polymer compositions, working with different catalytic systems in the various stages. In the first stage, olefinic polymer is prepared in the presence of titanium catalysts or vanadium catalyst. Then, a treatment stage in which the catalyst used previously is deactivated, and a third stage in which a metallocene compound is supported on the olefin polymer produced in the first stage, are carried out. Finally, a fourth stage of polymerization is accomplished in which one or more olefins are polymerized in the presence of the product obtained from the third stage. Although this process combines the advantages of different catalysts, the complex processes make it difficult for industrial practice. Moreover, the metallocene compound could not be separated well in the porous polymer particles obtained in the first stage, and the superfluous metallocene catalyst on the polymer particle surface would tend to increase the tackiness of the solid polymeric phase, resulting in fouling of the reactor.

It has now been found in accordance with this invention that a multistage process can be designed to produce a wide range of olefin polymer compositions conveniently with different catalytic systems only in two or more stages. In particular, a process according to this invention comprises a first stage, in which an olefin polymer is prepared selectively by Ziegler-Natta components of the Ziegler-Natta/metallocene hybrid catalysts, while the metallocene components are inactivated beforehand by inactivators, and a second stage in which one or more olefins are polymerized in the presence of the product obtained from the first stage, followed by a reactivation of the metallocene components by reactivators.

### SUMMARY OF THE INVENTION

A general object of the invention is to provide a process for preparation of a polyolefin alloy.

More particularly, the present invention relates to a process for preparation of a polyolefin alloy comprising the steps of:
1) adding hybrid catalyst, one or more olefins monomers and an inactivator having a structure of CH₂═CH—B into a reactor, allowing a first polymerization reaction as a slurry polymerization in alkane solvent having from 5 to 10 carbon atoms or aromatic solvent or as a bulk polymerization directly in olefins monomers, wherein the temperature for the first polymerization reaction is in the range of from about 0° C. to 80° C., wherein the inactivator is used in an amount of about 0. 1% to 20% based on the total weight of olefins monomers in the reactor, and wherein B is selected from the group consisting of phenyl, biphenyl, naphthyl, anthracenyl and substituted or unsubstituted phenanthrenyl wherein substituent groups are selected from alkyl and alkoxyl;
2) adding olefin monomers until the completion of the first polymerization reaction, then adding olefin monomers and activators needed in a second polymerization reaction, wherein the temperature for the second polymerization reaction is in the range of from about 60° C. to 120° C., and, further,
   wherein the olefin monomers used in the first polymerization reaction or the second polymerization reaction are selected from one or more of olefins having about 2 to 12, preferably 2 to 12, carbon atoms, dienes, cyclic olefins and norbornene.

Preferably, olefin monomers used in this invention are olefin monomers having about 3 to 12, preferably 3 to 12, carbon atoms. In some examples of the invention, the activator used is ethylene. In another example of the invention, the olefin monomer is propylene. It is understood that olefins monomers can be olefin monomers having about 3 to 12, preferably 3 to 12, carbon atoms, preferably propylene.

In a preferred embodiment, the activator used in a process of the invention is ethylene, and the amount of ethylene as activator is more than 1% based on the total weight of the hybrid catalyst.

In another preferred embodiment, in the process for preparation of a polyolefin alloy of the invention, the hybrid catalyst consists of a mixture mainly of a Ziegler-Natta catalyzing component and a metallocene catalyzing component on a weight percent basis of total catalyst in which the mixture comprises at least a member selected from the group consisting of:

a first compound having a transition metal M^{I} selected from titanium and vanadium without containing M^{I}-π bonds, wherein the transition metal M^{I} is present in an amount of about 0.1% to 20%, preferably 0.1% to 20%, by weight;

a second compound having a transition metal M selected from Ti, Zr, V or Hf containing at least one M-π bond, wherein the transition metal M is present in an amount of about 0.05% to 2%, preferably 0.05% to 2%, by weight;

magnesium halide, wherein the metal magnesium is present in an amount of about 5% to 20%, preferably 5% to 20%;

aluminoxane, wherein the metal Al is present in an amount of about 0.1% to 20%, preferably 0.1% to 20%, and

an internal electron-donor group as described below in an amount of about 1% to 30%, preferably 1% to 30%.

Preferably, the first compound in the hybrid catalyst is selected from halides of Ti, halo-alcoholates of Ti, VCl₃, VCl₄, VOCl₃ or halo-alcoholates of V. More preferably, the halide of Ti is TiCl₄, TiCl₃ or halo-alcoholates of formula Ti(OR^{I})ₘXₙ, in which R^{I} represents a alkyl group or alkoxy with 1 to about 12, preferably 1 to 12, carbon atoms, X represents a halogen, m and n=0 to about 4, and (m+n) equals the valency of the Ti. In another preferred embodiment, the magnesium halide in the hybrid catalyst is MgCl₂.

In another preferred embodiment, a process for preparation of a polyolefin alloy in accordance with the invention is characterized in that, in the hybrid catalyst, aluminoxane is a linear or non-linear compound having 1 to about 50, preferably 1 to 50, repeating units of the moiety —(R₄)AlO—, wherein R₄ represents alkyl or cycloalkyl having 1 to about 12, preferably 1 to 12, carbon atoms, or aryl having about 6 to 10, preferably 6 to 10, carbon atoms, and preferably the aluminoxane is methyl aluminoxane.

In another preferred embodiment, a process for preparation of a polyolefin alloy in accordance with the invention is characterized in that, in the hybrid catalyst, the internal electron-donor is selected from the group consisting of mono-esters, di-esters or diethers. More particularly, the internal electron-donor is selected from diethyl succinate, dibutyl adipate, diethyl phthalate, diisobutyl phthalate, 2,2-diisobutyl-1,3-dimethoxypropane and 9,9-bis(methoxymethyl) fluorine.

In another preferred embodiment, a process for preparation of a polyolefin alloy in accordance with the invention is characterized in that, in the hybrid catalyst, the second compound is a compound obtained from one or more ligands each having a mono- or polycyclic structure containing conjugated a electrons coordinating with the metal M.

Preferably the said second compound has a chemical formula selected from the group consisting of:

Cp^{I}MR¹ₐR²_{b}R³_{c} (I)

or

Cp^{I}Cp^{II}MR¹ₐR²_{b} (II)

or

(Cp^{I}-A_{c}-Cp^{II})MR¹₈R²_{b} (III)

in which M represents Ti, V, Zr or Hf; Cp^{I} and Cp^{II}, which may be the same or different, represent cyclopentadienyl groups, or substituted cyclopentadienyl groups; R¹, R² and R³, which may be the same or different, represent atoms of hydrogen, halogen, an alkyl or alkoxy group with 1 to about 20, preferably 1 to 20, carbon atoms, aryl or substituted aryl with about 6 to 20, preferably 6 to 20, carbon atoms, an acyloxy group with 1 to about 20, preferably 1 to 20, carbon atoms, an allyl group, or a substituent containing a silicon atom; A represents an alkyl bridge or one with structure selected from the group consisting of:

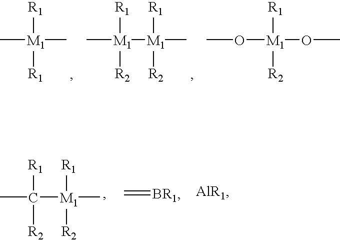

—Ge—, —Sn—, —O—, —S—, ═SO, ═SO₂, ═NR_{I}, ═PR₁, ═P(O)R₁, in which M₁ represents Si, Ge, or Sn; R₁ and R₂, which may be the same or different, represent alkyl groups with 1 to about 4, preferably 1 to 4, carbon atoms or aryl groups with about 6-10, preferably 6 to 10, carbon atoms; a, b and c represent, independently, integers of from 0 to about 4; e represents an integer of from 1 to about 6, preferably 1 to 6.

Preferably the compounds having a chemical structure according to formula (I) above are selected from the group consisting of (Me₅Cp)MMe₃, (Me₅Cp)M(OMe)₃, (Me₅Cp)MCl₃, (Cp)MCl₃, (Cp)MMe₃, (MeCp)MMe₃, (Me₃Cp)MMe₃, (Me₄Cp)MCl₃, (Ind)MBenz₃, (H₄Ind)MBenz₃, and (Cp)MBu₃.

Preferably the compounds having a chemical structure according to formula (II) above are selected from the group consisting of (Cp)₂MMe₂, (Cp)₂MPh₂, (Cp)₂MEt₂, (Cp)₂MCl₂, (Cp)₂M(OMe)₂, (Cp)₂M(OMe)Cl, (MeCp)₂MCl₂, (Me₅Cp)₂MCl₂, (Me₅Cp)₂MMe₂(Me₅Cp)₂MMeCl, (Cp)(Me₅Cp)MCl₂, (1-MeFlu)₂MCl₂, (BuCp)₂MCl₂, (Me₃Cp)₂MCl₂, (Me₄Cp)₂MCl₂, (Me₅Cp)₂M(OMe)₂, (Me₅Cp)₂M(OH)Cl, (Me₅Cp)₂M(OH)₂, (Me₅Cp)₂M(C₆H₅)₂, (Me₅Cp)₂M(CH₃)Cl, (EtMe₄Cp)MCl₂, [(C₆H₅)Me₄Cp]₂MCl₂, (Et₅Cp)₂MCl₂, (Me₅Cp)₂M(C₆H₅)Cl, (Ind)₂MCl₂, (Ind)₂MMe₂, (H₄Ind)₂MCl₂, (H₄Ind)₂MMe₂, {[Si(CH₃)₃]Cp}₂MCl₂, {[Si(CH₃)₃]₂MCl₂, and (Me₄Cp)(Me₅Cp)MCl₂.

Preferably the compounds having a chemical structure according to formula (III) above are selected from the group consisting of C₂H₄(Ind)₂MCl₂, C₂H₄(Ind)₂MMe₂, C₂H₄(H₄Ind)₂MCl₂, C₂H₄(H₄Ind)₂MMe₂, Me₂Si(Me₄Cp)₂MCl₂, Me₂Si(Me₄Cp)₂MMe₂, Me₂SiCp₂MCl₂, Me₂SiCp₂MMe₂, Me₂Si(Me₄Cp)₂MMeOMe, Me₂Si(Flu)₂MCl₂, Me₂Si(2-Et-5-iPrCp)₂MCl₂, Me₂Si(H₄Ind)₂MCl₂, Me₂Si(H₄Flu)₂MCl₂, Me₂SiCH₂(Ind)₂MCl₂, Me₂Si(2-Me-H₄Ind)₂MCl₂, Me₂Si(2-MeInd)₂MCl₂, Me₂Si(2-Et-5-iPr-Cp)₂MCl₂, Me₂Si(2-Me-5-Et-Cp)₂MCl₂, Me₂Si(2-Me-5-Me-Cp)₂MCl₂, Me₂Si(1-Me-7-benzoindenyl)₂ZrCl₂, Me₂Si(2-Me_{4,5}-benzoindenyl)₂MCl₂, Me₂Si(4,5-benzoindenyl)₂MCl₂, Me₂Si(2-EtInd)₂MCl₂, Me₂Si(2-iPr-Ind)₂MCl₂, Me₂Si(2-t-butyl-Ind)₂MCl₂, Me₂Si(3-t-butyl-5-MeCp)₂MCl₂, Me₂Si(3-t-butyl-5-MeCp)₂MMe₂, Me₂Si(2-MeInd)₂MCl₂, C₂H₄(2-Me-4,5-benzoindenyl)₂MCl₂, Me₂C(Flu)CpMCl₂, Ph₂Si(Ind)₂MCl₂, Ph(Me)Si(Ind)₂MCl₂, C₂H₄(H₄Ind)M(NMe₂)OMe, isopropylidene-(3-t-butyl-Cp)(Flu)MCl₂, Me₂C(Me₄Cp)(MeCp)MCl₂, MeSi(Ind)₂MCl₂, Me₂Si(Ind)₂MMe₂, Me₂Si(Me₄Cp)₂MCl(OEt), C₂H₄(Ind)₂M(NMe₂)₂, C₂H₄(Me₄Cp)₂MCl₂, C₂H₄(Ind)₂MCl₂, Me₂Si(3-Me-Ind)₂MCl₂, C₂H₄(2-Me-Ind)₂MCl₂, C₂H₄(3-Me-Ind)₂MCl₂, C₂H₄(4,7-Me-H₄Ind)₂MCl₂, C₂H₄(5,6-Me₂-Ind)₂MCl₂, C₂H₄(2,4,7-Me₃-Ind)₂MCl₂, C₂H₄(3,4,7-Me₃-Ind)₂MCl₂, C₂H₄(2-Me-H₄Ind)₂MCl₂, C₂H₄(4,7-Me₂-H₄Ind)₂MCl₂, C₂H₄(2,4,7-Me₃-H₄Ind)₂MCl₂, Me₂Si(4,7-Me₂-Ind)₂MCl₂, Me₂Si(5,6-Me₂-Ind)₂MCl₂, and Me₂Si(2,4,7-Me₃-H₄Ind)₂MCl₂.

In a preferred embodiment of a process for preparation of a polyolefin alloy in accordance with the invention, the amount of the inactivator present is in a range of from about 0.5% to 2%, preferably 0.5% to 2%, based on the total weight of olefin monomers in the reactor. Preferably the temperature for the first polymerization reaction is in the range of from about 40° C. to 75° C., preferably 40° C. to 75° C., and the temperature for the second polymerization reaction is in the range of from about 75° C. to 95° C., preferably 75° C. to 95° C.

In a preferred embodiment, alkyl aluminum is further added as a co-catalyst in the first polymerization reaction in an amount wherein the weight ratio (W/W) of Al/Ti=1 to about 1000, more preferably Al/Ti=50 to 200. In another preferred embodiment, the alkyl aluminum is trialkyl aluminum, or mixtures of trialkyl aluminum with halogenated or multi halogenated alkyl aluminum.

In another preferred embodiment of a process for preparation of a polyolefin alloy in accordance with the invention, an external electron-donor group is further added in the first polymerization reaction in an amount of the external electron-donor group ranging from about 1, or less than 1, to about 100 times, for example 0-100 times, by mole relative to that of the element Ti in the hybrid catalyst. Preferably the external electron-donor group is selected from the group consisting of mono-esters, di-esters and diethers.

Preferably, when the internal electron-donor group or material in the hybrid catalyst is a carboxylate, the external electron-donor group or material is an S organosilicon compound having an Si—O unit in the formula R₁R₂Si(OR)₂, in which R₁ and R₂ independently represent alkyl, cycloalkyl with from 1 to about 18, preferably 1 to 18, carbon atoms, or aryl groups, and R represents an alkyl radical with from 1 to about 5, preferably 1 to 5 carbon atoms.

In another preferred embodiment of a process for preparation of a polyolefin alloy in accordance with the invention, the process of the invention comprises the steps of:

charging spherical alcoholate MgCl₂ carrier, with a molar ratio of an alcohol having about 2 to 4, preferably 2 to 4, carbon atoms relative to MgCl₂ in a range of about 1:1 to 4:1, preferably 1:1 to 4:1, into a preparing bottle under a temperature of about −20° C. to 10° C., preferably −20° C. to 10° C., incorporating the first compound having a transition metal M^{I} selected from titanium and vanadium without containing M^{I}-π bonds, wherein the transition metal M^{I} is present in an amount of about 0.1% to 20%, preferably 0.1% to 20%, by 5 ml to 50 ml per gram of carrier;

stirring and increasing the reaction temperature gradually, incorporating the internal electron-donor material when the temperature reaches about 50° C. to about 90° C., preferably 50° C. to 90° C.; then increasing the temperature to about 100° C. to about 150° C., preferably 100° C. to 150° C.; stirring and filtering, then incorporating about 5 ml to 50 ml, preferably 5 ml to 50 ml, additional first compound; followed by stirring and filtering at about 100° C. to about 150° C., preferably 100° C. to 150° C.; and,

mixing a mixed solution of the aluminoxane and the second compound fully stirred at about −25° C. to 25° C., preferably −25° C. to 25° C., with a spherical Ziegler-Natta catalyzing component, wherein every grain of Ziegler-Natta catalyzing component corresponds about to 1×10⁻⁶ mol to about 5.6×10⁻⁴ mol, preferably 1×10⁻⁶ mol to 5.6×10⁻⁴ mol, of the second compound, the temperature for mixing being in the range of about 0° C. to 80° C., preferably 0° C. to 80° C.; then washing by alkane solvent having about 5 to 10, preferably 5 to 10, carbon atoms or aromatic solvents, and drying to obtain the hybrid catalyst.

In a preferred embodiment, the spherical Ziegler-Natta catalyzing component of this invention is prepared by charging spherical alcoholate MgCl₂ carrier with a molar ratio of an alcohol having about 2 to 4, preferably 2 to 4, carbon atoms relative to MgCl₂ in a range of about 1:1 to 4: 1, preferably 1:1 to 4:1, into a preparing bottle under a temperature of about −20° C. to 0° C., preferably −20° C. to 0° C., incorporating the first compound in an amount of about 10 ml to 50 ml, preferably 10 ml to 50 ml, per gram of carrier; incorporating the internal electron-donor group when the temperature reaches to about 50° C. to about 90° C., preferably 50° C. to 90° C.; then increasing the temperature to about 100° C. to about 150° C., preferably 100° C. to 150° C., further incorporating about 5 ml to 50 ml, preferably 5 ml to 50 ml, of the first compound, stirring at about 100° C. to about 150° C., preferably 100° C. to 150° C., and filtering. Still more preferably, every gram of Ziegler-Natta catalyzing component corresponds to about 2×10⁻⁵ mol to about 1.0×10⁻⁴ mol, preferably 2×10⁻⁵ mol to 1.0×10⁻⁴ mol, of the second compound.

In other words, in the preparation of polyolfin monomers, the objective of this invention is to obtain polyolefin alloy particles having excellent morphology, adjustable composition and uniform structure.

In the invention, a hybrid catalyst comprised of (I) a Ziegler-Natta catalyzing component, and (II) a metallocene catalyzing component is used.

Firstly, catalyst component (I) in the hybrid catalyst is activated under suitable conditions, at the same time an inactivator is added to inactivate the catalyst component (II) in the hybrid catalyst. Component (I) initiates homopolymerization or copolymerization of olefins. Spherical porous particulate polyolefins are obtained by bulk polymerization, slurry polymerization or gas-phase polymerization. Inactivated catalyst component (II) is thereby relatively uniformly dispersed in inner-surfaces of cells of the polyolefin particles.

After that, catalyst component (II) which is dispersed in inner-surfaces of cells of polyolefin particles is reactivated by adding a suitable activator. Copolymerization of various olefins is thereby initiated by catalyst component (II). Olefin copolymer can be uniformly dispersed in cells of the above obtained polyolefin particles by slurry polymerization or gas-phase polymerization utilizing the reactivated catalyst component (II).

In particular, the present invention provides a process for the preparation of polyolefin alloy, especially polyprepolyene alloy, comprising the following steps (1) and (2):
Step 1: adding a hybrid catalyst, one or more olefins monomers (especially propylene monomer) and at least an inactivator into a reactor; and allowing a slurry polymerization in an alkane solvent having from about 5 to 10 carbon atoms or an aromatic solvent, or a bulk polymerization directly in olefins monomers, wherein the temperature for the reaction is in the range of about 0° C. to 80° C., preferably about 40° C. to 75° C.;
   wherein the structure of the inactivator is CH₂═CH—B, wherein B is selected from the group consisting of phenyl, biphenyl, naphthyl, anthracenyl, and substituted or unsubstituted phenanthrenyl with substituents selected from alkyl and alkoxyl, such as styrene and 4-methyl-styrene. The inactivator is used in an amount of about 0.1 wt. % to 20 wt. % based on the total weight of olefin monomers in the reactor, preferably from about 0.5 wt. % to 20 wt. %.

In this step, alkyl aluminum can be further added as co-catalyst in a weight ratio of Al/Ti=1˜1000, more preferably Al/Ti=50˜200. The alkyl aluminum can be trialkyl aluminum, such as triethyl aluminum, triisobutyl aluminum, tri-n-butyl aluminum, tri-n-hexyl aluminum, tri-n-octyl aluminum; or mixtures of trialkyl aluminum with halogenated or multi-halogenated alkyl aluminum, such as mixtures with AlEt₂Cl or Al₂Et₃Cl₃.

External electron-donor groups can be further added to control the isotacticity of the polymer. The external electron-donor group is typically added in an amount ranging from about 1, or less than 1, to about 100 times by mole relative to the amount of Ti element. The said external electron-donor can be same as or different from the internal electron-donor. Preferably when the internal electron-donor in the hybrid catalyst is a carboxylate, the external electron-donor is a organosilicon compound having an Si—O unit in the formula R₁R₂Si(OR)₂, in which R₁ and R₂ independently are alkyl, cycloalkyl with from 1 to about 18 carbon atoms, or aryl groups, and R is an alkyl radical with from 1 to about 5 carbon atoms. In particular, the external electron-donor includes, for example, tetramethoxy silane, dimethyl-dimethoxy silane, tetraethoxy silane, triethoxy ethyl silane, dicyclopentoxy diethyl silane, diphenyl dimethoxy silane, and diphenyl diethoxy silane.
Step 2: stopping the addition of olefin monomers used in the first polymerization reaction after the substantial completion of the first polymerization reaction, then adding olefin monomers and activators needed in a second polymerization reaction; wherein the temperature for the second polymerization reaction is in the range of about 60° C. to 120° C., preferably about 75° C. to 95° C. The reaction monomers used in the second step of the reaction are selected from one or more olefins having from about 2 to 12 carbon atoms, dienes, cyclic olefins and norbornene. The preferred activator used in this step of the process of the invention is ethylene. The amount of the activator ethylene is typically more than 1% based on the total weight of the hybrid catalyst. At the same time the ethylene can also be conveniently used as comonomer in step 2.

The second step of the reaction can be accomplished by any of three ways as follows:

Firstly, after the completion of the step (1) polymerization, monomers for the second step reaction can be directly charged into the first polymer of step (1) for slurry polymerization; or

Secondly, the liquid part of the first polymerization production of step 1 is removed, then solvents such as alkane having from about 5 to 10 carbon atoms or aromatics are incorporated, then reaction monomers are included for slurry polymerization; or

Thirdly, the reaction monomers for the second step are incorporated directly for gas-phase polymerization after the liquid part of the first polymerization product from step (1) is removed.

Alkyl aluminum or alkyl aluminoxane can be further incorporated as co-catalyst in step (2) in an amount based on a mole ratio of aluminum to metallocene element in hybrid catalyst ranging from about 1, or less than 1, to about 16000.

The reaction of the invention can be carried out in a reactor, preferably in a two-stage reactor in series. In the process of the invention: in step 1, propylene homopolymer with high isotacticity or olefin copolymer having a copolymer level of less than about 10% can be obtained; in step 2, random copolymer of olefins, such as ethylene/α-olefin copolymer, can be obtained, wherein the amount of ethylene in the copolymer is about 20 to 90% by weight; olefin copolymer obtained in step 2 is typically about 3% to 80% by weight based on the total weight of polymer obtained from both step 1 and step 2.

The hybrid catalyst of the invention consists mainly of a mixture of Ziegler-Natta catalyzing component and metallocene catalyzing component, by weight percentage, comprising:
Component I: a first compound having a transition metal M^{I} selected from titanium and vanadium without containing M^{I}—π bonds, wherein the transition metal M^{I} is in an amount of about 0.1% to 20%;
Component II: a second compound having a transition metal M selected from Ti, Zr, V or Hf containing at least one M-π bond, wherein the transition metal M is in an amount of about 0.05% to 2%;
Component III: a magnesium halide, wherein the amount of metal magnesium is in the range of about 5% to 20%
Component IV: an aluminoxane, wherein the metal Al is in an amount of about 0.1% to 20%;
Component V: an internal electron-donor in the amount of about 1% to 30%.

In the component I of the hybrid catalyst, as described above, the compound of transition metal M^{I} is selected from the group consisting of halides of Ti, halo-alcoholates of Ti, VCl₃, VCl₄, VOCl₃ or halo-alcoholates of V; more preferably, the compound of Ti is TiCl₄, TiCl₃ or halo-alcoholates of formula Ti(OR^{I})ₘXₙ, in which R^{I} is a alkyl group or alkoxy with 1 to about 12 carbon atoms, X is a halogen, m, n=0˜4, and (m+n) is the valency of the Ti.

In component II of the hybrid catalyst, as described above, the compound of transition metal M is a compound obtained from one or more ligands each having a mono- or polycyclic structure containing conjugated π electrons coordinating with the metal M. The compound of Ti, Zr, V or Hf has a chemical formula selected from the group consisting of:

Cp^{I}MR¹ₐR²_{b}R³_{c} (I)

or

Cp^{I}Cp^{II}MR¹ₐR²_{b} (II)

or

(Cp^{I}-A_{c}-Cp^{II})MR¹ₐR²_{b} (III)

in which M is Ti, V, Zr or Hf; Cp^{I} and Cp^{II}, which may be the same or different, are cyclopentadienyl groups, or substituted cyclopentadienyl groups; R¹, R² and R³, which may be the same or different, are atoms of hydrogen, halogen, an alkyl or alkoxy group with 1 to about 20 carbon atoms, aryl or substituted aryl with about 6 to 20 carbon atoms, an acyloxy group with 1 to about 20 carbon atoms, an allyl group, or a substituent containing a silicon atom; A is an alkyl bridge or one with structure selected from the group consisting of:

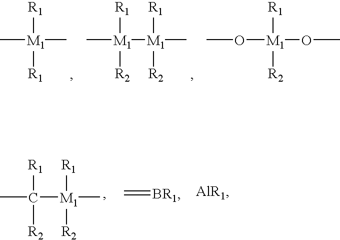

—Ge—, —Sn—, —O—, —S—, ═SO, ═SO₂, ═NR₁, ═PR₁, ═P(O)R₁, in which M₁ is Si, Ge, or Sn; R₁ and R₂, which may be the same or different, are alkyl groups with 1 to about 4 carbon atoms or aryl groups with about 6-10 carbon atoms; a, b and c are, independently, integers of from 0 to about 4; e is an integer of from 1 to about 6.

Preferably the compounds having a chemical structure according to formula (I) above are selected from the group consisting of (Me₅Cp)MMe₃, (Me₅Cp)M(OMe)₃, (Me₅Cp)MCl₃, (Cp)MCl₃, (Cp)MMe₃, (MeCp)MMe₃, (Me₃Cp)MMe₃, (Me₄Cp)MCl₃, (Ind)MBenz₃, (H₄Ind)MBenz₃, and (Cp)MBu₃.

Preferably the compounds having a chemical structure according to formula (II) above are selected from the group consisting of (Cp2MMe₂, (Cp)₂MPh₂, (Cp)₂MEt₂, (Cp)₂MCl₂, (Cp)₂M(OMe)₂, (Cp)₂M(OMe)Cl, (MeCp)₂MCl₂, (Me5Cp)₂MCl₂, (Me₅Cp)₂MMe₂, (Me₅Cp)₂MMeCl, (Cp)(Me₅Cp)MCl₂, (1-MeFlu)₂MCl₂, (BuCp)₂MCl₂, (Me₃Cp)₂MCl₂, (Me₄Cp)₂MCl₂, (Me₅Cp)₂M(OMe)₂, (Me₅Cp)₂M(OH)Cl, (Me₅Cp)₂M(OH)₂, (Me₅Cp)₂M(C₆H₅)₂, (Me₅Cp)₂M(CH₃)Cl, (EtMe₄Cp)MCl₂, [(C₆H₅)Me₄Cp]₂MCl₂, (Et₅Cp)₂MCl₂, (Me₅Cp)₂M(C₆H₅)Cl, (Ind)₂MMe₂, (H₄Ind)₂MCl₂, (H₄Ind)₂MMe₂, {[Si(CH₃)₃]Cp}₂MCl₂, {[Si(CH₃)₃[₂Cp}₂MCl₂, and (Me₄Cp)(Me₅Cp)MCl₂.

Preferably the compounds having a chemical structure according to formula (III) above are selected from the group consisting of C₂H₄(Ind)₂MCl₂, C₂H₄(Ind)₂MMe₂, C₂H₄(H₄Ind)₂MCl₂, C₂H₄(H₄Ind)₂MMe₂, Me₂Si(Me₄Cp)₂MCl₂, Me₂Si(Me₄Cp)₂MMe₂, Me₂SiCp₂MCl₂, Me₂SiCp₂MMe₂, Me₂Si(Me₄Cp)₂MMeOMe, Me₂Si(Flu)₂MCl₂, Me₂Si(2-Et-5-iPrCp)₂MCl₂, Me₂Si(H₄Ind)₂MCl₂, Me₂Si(H₄Flu)₂MCl₂, Me₂SiCH₂(Ind)₂MCl₂, Me₂Si(2-Me-H₄Ind)₂MCl₂, Me₂Si(2-MeInd)₂MCl₂, Me₂Si(2-Et-5-iPr-Cp)₂MCl₂, Me₂Si(2-Me-5-Et-Cp)₂MCl₂, Me₂Si(2-Me-5-Me-Cp)₂MCl₂, Me₂Si(1-Me-7-benzoindenyl)₂ZrCl₂, Me₂Si(2-Me_{4,5}-benzoindenyl)₂MCl₂, Me₂Si(4,5-benzoindenyl)₂MCl₂, Me₂Si(2-EtInd)₂MCl₂, Me₂Si(2-iPr-Ind)₂MCl₂, Me₂Si(2-t-butyl-Ind)₂MCl₂, Me₂Si(3-t-butyl-5-MeCp)₂MCl₂, Me₂Si(3-t-butyl-5-MeCp)₂MMe₂, Me₂Si(2-MeInd)₂MCl₂, C₂H₄(2-Me-4,5-benzoindenyl)₂MCl₂, Me₂C(Flu)CpMCl₂, Ph₂Si(Ind)₂MCl₂, Ph(Me)Si(Ind)₂MCl₂, C₂H₄(H₄Ind)M(NMe)OMe, isopropylidene-(3-t-butyl-Cp)(Flu)MCl₂, Me₂C(Me₄Cp)(MeCp)MCl₂, MeSi(Ind)₂MCl₂, Me₂Si(Ind)₂MMe₂, Me₂Si(Me₄Cp)₂MCl(OEt), C₂H₄(Ind)₂M(NMe₂)₂, C₂H₄(Me_{4l Cp)}₂MCl₂, C₂H₄(Ind)₂MCl₂, Me₂Si(3-Me-Ind)₂MCl₂, C₂H₄(2-Me-Ind)₂MCl₂, C₂H₄(3-Me-Ind)₂MCl₂, C₂H₄(4,7-Me-H₄Ind)₂MCl₂, C₂H₄(5,6-Me₂-Ind)₂MCl₂, C₂H₄(2,4,7-Me₃-Ind)₂MCl₂, C₂H₄(3,4,7-Me₃-Ind)₂MCl₂, C₂H₄(2-Me-H₄Ind)₂MCl₂, C₂H₄(4,7-Me₂-H₄Ind)₂MCl₂, C₂H₄(2,4,7-Me₃-H₄Ind)₂MCl₂, Me₂Si(4,7-Me₂-Ind)₂MCl₂, Me₂Si(5,6-Me₂-Ind)₂MCl₂, or Me₂Si(2,4,7-Me₃-H₄Ind)₂MCl₂.

Abbreviations as used in above chemical structures are as follows for purposes of this patent application: Me=methyl, Et=ethyl, iPr=isopropyl, Bu=butyl, Ph=phenyl, Cp=cyclopentadienyl, Ind=indenyl, H₄Ind=4,5,6,7-tetrahydroindenyl, Flu=fluorine, Benz=benzyl, M=Ti, Zr or Hf, preferably Zr.

Component III in the hybrid catalyst is a catalyst carrier, preferably MgCl₂.

In component IV of the hybrid catalyst, the aluminoxane is a linear or non-linear compound having 1 to about 50 repeating units of —(R₄)AlO—, wherein R₄ is alkyl or cycloalkyl having 1 to about 12 carbon atoms, or aryl having about 6 to 10 carbon atoms, and preferably the aluminoxane is methyl aluminoxane.

In component V of the hybrid catalyst, the internal electron-donor includes mono-esters, di-esters or diethers; more particularly, the internal electron-donor is diethyl succinate, dibutyl adipate, diethyl phthalate, diisobutyl phthalate, 2,2-diisobutyl-1,3-dimethoxypropane or 9,9-bis(methoxymethyl) fluorine.

The hybrid catalyst of this invention is typically prepared by two steps:

### (1) Preparation of Spherical Ziegler-Natta Catalyst

A spherical Ziegler-Natta catalyst as used in this invention can be prepared according to processes disclosed in CN1110281A, CN1047302A, CN1091748A or U.S. Pat. No. 4,399,054, each of which is incorporated herein by reference, or prepared according to the following process:

Spherical alcoholate MgCl₂ carrier with a molar ratio of alcohol to MgCl₂ of about 1:1 to 4:1 is charged into a preparing bottle (alcohol can be an alcohol having about 2 to 4 carbon atoms), under a temperature of about −20° C. to 10° C.; preferably about −20° C. to 0° C.; component I (especially TiCl₄ or TiCl₃) is incorporated according to about 5 ml to 50 ml component I (TiCl₄ or TiCl₃) per gram carrier, preferably about 10 ml to 50 ml component I per gram carrier; the mixture is stirred and the temperature gradually raised, incorporating the internal electron-donor when the temperature reaches to about 50° C.˜90° C.; then the temperature is further raised to about 100° C.˜150° C.; after stirring and filtering, about 5 ml to 50 ml of additional component I (TiCl₄ or TiCl₃) as incorporated into the mixture, followed by further stirring and filtering at about 100° C.˜150° C.;

The spherical catalyst thus prepared can be fully washed by an alkane (pentane, hexane, heptane etc.) solvent or not as desired.

### (2) Preparation of the Hybrid Catalyst

A mixed solution of the component IV and component II is fully stirred at about −25° C. to 25° C. and is mixed with a spherical Ziegler-Natta catalyzing component, such as that prepared by step (1) above, wherein every gram of Ziegler-Natta catalyzing component corresponds to about 1×10⁻⁶ mol to 5.6×10⁻⁴ mol of the component II, preferably about 2×10⁻⁵ mol to 1.0×10⁻⁴mol; the temperature for mixing is in the range of about 0° C. to 80° C., followed by stirring and then filtering, and then washing by an alkane solvent having about 5 to 10 carbon atoms or aromatic solvents, followed by drying to obtain the hybrid catalyst.

The hybrid catalyst can further comprise an external electron-donor which can be incorporated during catalyzing a polymerization according to the requirements of the reaction The external electron-donor can be same or different from said internal electron-donor, and can be mono-esters, di-esters or diethers, and also can be siloxane. Also, alkyl aluminum or alkyl aluminoxane may be used as co-catalyst.

In the invention, the Ziegler-Natta catalyzing component in the hybrid catalyst plays a role in the first step of olefin polymerization, then the metallocene catalyzing component is activated in the second step to play a role in ethylene homopolymerization or copolymerization. Polymers with excellent morphology can be obtained by the use of a heterogeneous Ziegler-Natta catalyst; also, molecular design can be also carried out by the use of features of a metallocene catalyst according to a specific desired application by adjusting the properties of the resulting polymer alloy. Compared with the prior art, the prepared polymer particles according to this invention have a generally regular spherical shape, and copolymers are uniformly dispensed in cells of polymer particles, thus ensuring that problems such as aggregation of the product, adhesion to reactor walls, etc. will not occur during polymerization. The procedure of the polymerization according to this invention is simple and can easily be industrialized.

### DETAILED DESCRIPTION OF THE PREFERRED EMBODIMENTS

The following examples are intended to be illustrative of the present invention and should in no way be construed as limiting the scope of this invention.

### EXAMPLES

### Example 1

### Preparation of the Hybrid Catalyst A

100 ml TiCl₄ were added to a reaction system under nitrogen blanket into a 500 ml flask equipped with a sintered filter at the bottom and a mechanical stirrer. And then the system was cooled to −20° C. 5g spherical carrier of MgCl₂.nEtOH was added for reaction for 1 hour. The system was then heated to 50° C., then 0.7 g diisobutyl phthalate was added. System temperature was gradually raised to 120° C. The reaction was carried out for 2 hours, then the system was filtered. Then 100 ml TiCl₄ were further added and the reaction was maintained at 120° C. for 2 hours. The product was washed by hexane at 60° C. to obtain component “a.”

0.03 g C₂H₄(Ind)₂ZrCl₂ and 0.02 mol methylaluminoxane (MAO) were added to component “a” after reacting at 20° C. for 2 hours, and the system was kept at reaction conditions for 2 hours at 20° C. The obtained product was fully washed by hexane, and then dried under vacuum at room temperature for 1 hour. The composition of the obtained hybrid catalyst A included Ti 3.3 wt %, Zr 0.17 wt %, Al 6.3 wt %, Mg 12.4 wt %, and diisobutyl phthalate 10.2 wt %.

### Example 2

### Preparation of the Hybrid Catalyst B

100 ml TiCl₄ was added to a reaction system under nitrogen blanket into a 500 ml flask equipped with a sintered filter at the bottom and a mechanical stirrer. And then the system was cooled to −20° C., 5 g spherical carrier MgCl₂.nEtOH was added for reaction for 1 h. The system was heated to 60° C., then 0.65 g 9,9-bis(methoxymethyl)fluorene (BMF) was added. The system temperature was gradually raised to 120° C. The reaction was carried out for 2 hours, then the system was filtered. Then 100 ml TiCl₄ were further added and the reaction was maintained at 120° C. for 2 hours. The product was washed by hexane at 60° C. to obtain component “b.”

0.1 g C₂H₄(Ind)₂ZrCl₂ and 0.05 mol methylaluminoxane (MAO) were added to component “b” after reacting at 20° C. for 2 hours, and the system was kept at reaction conditions for 2 hours at 20° C. The obtained product was fully washed by hexane, then dried under vacuum at room temperature for 1 hour. The composition of the obtained hybrid catalyst B included Ti 2.8 wt %, Zr 0.83 wt %, Al 9.8 wt %, Mg 9.8 wt % and BMF 9.5 wt %.

### Example 3

### Preparation of the Hybrid Catalyst C

100 ml TiCl₄ were added to a reaction system under nitrogen blanket into a 500 ml flask equipped with a sintered filter at the bottom and a mechanical stirrer. And then the system was cooled to −20° C., 5 g spherical carrier MgCl₂.nEtOH was added for reaction for 1 h. The system was heated to 60° C., then 0.65 g 9,9-bis(methoxymethyl) fluorene (BMF) was added. The system temperature was gradually raised to 120° C. The reaction was carried out for 2 hours, then the system was filtered. Then 100 ml TiCl₄ were further added and the reaction was maintained at 120° C. for 2 hours. The product was washed by hexane at 60° C. to obtain component “c.”

0.7 g Me₂Si(1-Me-7-benzoindenyl)₂ZrCl₂ and 0.03 mol methylaluminoxane (MAO) were added to component “c” after reacting at 20° C. for 2 hours, and the system was maintained at reaction condition for 2 hours at 20° C. The obtained product was fully washed by hexane, then dried under vacuum at room temperature for 1 hour. The composition of the obtained hybrid catalyst C included Ti 2.9 wt %, Zr 0.45 wt %, Al 8.1 wt %, Mg 11.3 and BMF 11.4 wt %.

### Example 4

### Preparation of Polyolefin Alloy

### (1): Preparation of PP Homopolymer

1500 g liquid propylene and 9.06 g styrene were added to a 10 L polymerization reaction vessel; 0.076 g diphenyldimethoxysilane (DDS), 0.36 g triethylaluminum (TEA) and 0.05 g hybrid catalyst A were added sequentially at 30° C. The temperature was increased to 75° C.; the reaction time was 90 min. The amount of polypropylene obtained was 742 g.

### (2): Copolymerization of Ethylene and Propylene

Residual propylene in the reaction vessel of step 1 of this Example was evacuated, and the temperature was decreased to 30° C., a mixed gas of 100 g ethylene and 50 g propylene was added, and the temperature was increased to 90° C. The reaction was maintained for 30 min to obtain 863 g of product finally The structure and properties of the product from this Example are shown in Table 1 below.

### Example 5

### Preparation of Polyolefin Alloy

### (1): Preparation of PP Homopolymer

1500 g liquid propylene and 36 g styrene were added to a 10 L polymerization reaction vessel; 0.42 g triethylaluminum (EA) and 0.05 g hybrid catalyst B were added sequentially at 30° C. The temperature was increased to 75° C.; the reaction time was 90 min. The amount of polypropylene obtained was 850 g.

### (2): Copolymerization of Ethylene and Propylene

Residual propylene in the reaction vessel of step 1 of this Example was evacuated at 40° C., a mixed gas of 100 g ethylene and 50 g propylene was added to the reaction vessel containing polypropylene obtained in step 1, and the temperature was increased to 90° C. The reaction was maintained for 30 min to obtain 992 g of product finally. The structure and properties of the product from this Example are shown in Table 1 below.

### Example 6

### Preparation of Polyolefin Alloy

### (1): Preparation of PP Homopolymer

1500 g liquid propylene and 36 g styrene were added to a 10 L polymerization reaction vessel; 0.42 g triethylaluminum (TEA) and 0.05 g hybrid catalyst B were added sequentially at 30° C. The temperature was increased to 75° C.; the reaction time was 90 min. The amount of polypropylene obtained was 850 g.

### (2): Copolymerization of Ethylene and Propylene

Residual propylene in the reaction vessel of step 1 of this Example was evacuated, and the temperature was decreased to 30° C., a mixed gas of 75 g ethylene and 100 g propylene was added, and the temperature was increased to 90° C. The reaction was maintained for 30 min to obtain 1010 g of product finally. The structure and properties of the product from this Example are shown in Table 1 below.

### Example 7

### Preparation of Polyolefin Alloy

### (1): Preparation of PP Homopolymer

1500 g liquid propylene and 36 g styrene were added to a 10 L polymerization reaction vessel; 0.42 g triethylaluminum (TEA), 0.15 g methyl aluminoxane (MAO) and 0.05 g hybrid catalyst B were added sequentially at 30° C. The temperature was increased to 75° C.; the reaction time was 90 min. The amount of polypropylene obtained was 890 g.

### (2): Copolymerization of Ethylene and Propylene

Residual propylene in the reaction vessel of step 1 of this Example was evacuated, and the temperature was decreased to 30° C., a mixed gas of 100 g ethylene and 150 g propylene was added, and the temperature was increased to 90° C. The reaction was maintained for 30 min to obtain 1115 g of product finally. The structure and properties of the product from this Example are shown in Table 1 below.

### Example 8

### Preparation of Polyolefin Alloy

### (1): Preparation of PP Homopolymer

1500 g liquid propylene and 23 g styrene were added to a 10 L polymerization reaction vessel; 0.076 g diphenyldimethoxysilane (DDS), 0.42 g triethylaluminum (TEA) and 0.05 g hybrid catalyst C were added sequentially at 30° C. The temperature was increased to 75° C.; the reaction time was 90 min. The amount of polypropylene obtained was 690 g.

### (2): Copolymerization of Ethylene and Propylene

Residual propylene in the reaction vessel of step 1 of this Example was evacuated, and the temperature was decreased to 30° C., a mixed gas of 100 g ethylene and 100 g propylene was added, and the temperature was increased to 90° C. The reaction was maintained for 30 min to obtain 872 g of product finally. The structure and properties of the product from this Example are shown in Table 1 below.

### Example 9

### Preparation of Polyolefin Alloy

### (1): Preparation of PP Homopolymer

1500 g liquid propylene was added to a 10 L polymerization reaction vessel; 0.076 g diphenyldimethoxysilane (DDS), 0.42 g triethylaluminum (TEA) and 0.05 g hybrid catalyst C were added sequentially at 30° C. The temperature was increased to 75° C.; the reaction time was 90 min. The amount of polypropylene obtained was 1080 g.

### (2): Copolymerization of Ethylene and Propylene

Residual propylene in the reaction vessel of step 1 of this Example was evacuated, and the temperature was decreased to 30° C., a mixed gas of 100 g ethylene and 100 g propylene was added, and the temperature was increased to 90° C. The reaction was maintained for 30 min to obtain 1278 g of product finally. The structure and properties of the product from this Example are shown in Table 1 below.

### Example 10

### Preparation of Polyolefin Alloy

### (1): Preparation of PP Homopolymer

1500 g liquid propylene and 36 g 4-methyl-styrene were added to a 10 L polymerization reaction vessel; 0.42 g triethylaluminum (TEA) and 0.05 g hybrid catalyst B were added sequentially at 30° C. The temperature was increased to 75° C.; the reaction time was 90 min. The amount of polypropylene obtained was 850 g.

### (2): Copolymerization of Ethylene and Propylene

Residual propylene in the reaction vessel of step 1 of this Example was evacuated, and the temperature was decreased to 30° C., a mixed gas of 150 g ethylene and 260 g propylene was added, and the temperature was increased to 90° C. The reaction was maintained for 90 min to obtain 1190 g of product finally. The structure and properties of the product from this Example are shown in Table 1 below.

### Example 11

### Preparation of Polyolefin Alloy

### (1): Preparation of PP Homopolymer

1500 g liquid propylene and 36 g 4-methyl-styrene were added to a 10 L polymerization reaction vessel; 0.42 g triethylaluminum (TEA) and 0.05 g hybrid catalyst B were added sequentially at 30° C. The temperature was increased to 75° C.; the reaction time was 90 min. The amount of polypropylene obtained was 850 g.

### (2): Copolymerization of Ethylene and Propylene

Residual propylene in the reaction vessel of step 1 of this Example was evacuated, and the temperature was decreased to 30° C., a mixed gas of 300 g ethylene and 500 g propylene was added, and the temperature was increased to 90° C. The reaction was maintained for 150 min to obtain 1560 g of product finally. The structure and properties of the product from this Example are shown in Table 1 below.

### Example 12

### Preparation of Polyolefin Alloy

### (1): Preparation of PP Homopolymer

1500 g liquid propylene and 36 g styrene were added to a 10 L polymerization reaction vessel; 0.42 g triethylaluminum (TEA) and 0.05 g hybrid catalyst B were added sequentially at 30° C. The temperature was increased to 75° C.; the reaction time was 120 min. The amount of polypropylene obtained was 1010 g.

(2): Copolymerization of Ethylene/1-butylene

Residual propylene in the reaction vessel of step 1 of this Example was evacuated, and the temperature was decreased to 30° C., a mixed gas of 200 g ethylene and 360 g 1-butylene was added, and the temperature was increased to 90° C. The reaction was maintained for 90 min to obtain 1500 g of product finally. The structure and properties of the product from this Example are shown in Table 1 below.

### Example 13

### Preparation of Polyolefin Alloy

### (1): Preparation of PP Homopolymer

3.5 L anhydrous hexane was added to a 10 L polymerization reaction vessel; 36 g styrene, 0.81 g triethylaluminum (TEA) and 0.05 g hybrid catalyst B were added at 30° C. Propylene gas was added to keep the pressure inside the vessel at 10 atm. The temperature was increased to 70° C.; the reaction time was 120 min. The amount of polypropylene obtained was 300 g.

(2): Copolymerization of Ethylene /1-hexene

Residual propylene in the reaction vessel of step 1 of this Example was evacuated, and the temperature was decreased to 30° C., 100 g ethylene and 45 g 1-hexene were added, and the temperature was increased to 85° C. The reaction was maintained for 90 min to obtain 336 g of product finally. The structure and properties of the product from this Example are shown in Table 2 below.

### Example 14

### Preparation of Polyolefin Alloy

### (1): Preparation of PP Homopolymer

3.5 L anhydrous hexane was added to a 10 L polymerization reaction vessel; 36 g styrene, 0.81 g triethylaluminum (TEA) and 0.05 g hybrid catalyst B were added at 30° C. Propylene gas was added to keep the pressure inside the vessel at 10 atm. The temperature was increased to 70° C.; the reaction time was 120 min. The amount of polypropylene obtained was 300 g.

(2): Copolymerization of Ethylene /1-hexene

Residual propylene in the reaction vessel of step 1 of this Example was evacuated, and the temperature was decreased to 30° C., 100 g ethylene and 80 g 1-hexene were added, and the temperature was increased to 85° C. The reaction was maintained for 90 min to obtain 356 g of product finally. The structure and properties of the product from this Example are shown in Table 2 below.

### Example 15

### Preparation of Polyolefin Alloy

### (1): Preparation of PP Homopolymer

3.5 L anhydrous hexane was added to a 10 L polymerization reaction vessel; 36 g styrene, 0.81 g triethylaluminum (TEA) and 0.05 g hybrid catalyst B were added at 30° C. Propylene gas was added to keep the pressure inside the vessel at 10 atm. The temperature was increased to 70° C.; the reaction time was 120 min. The amount of polypropylene obtained was 300 g.

(2): Copolymerization of Ethylene /1-octene

Residual propylene in the reaction vessel of step 1 of this Example was evacuated, and the temperature was decreased to 30° C., 70 g ethylene and 50 g 1-octene were added, and the temperature was increased to 85° C. The reaction was maintained for 90 min to obtain 329 g of product finally. The structure and properties of the product from this Example are shown in Table 2 below.

### Example 16

### Preparation of Polyolefin Alloy

### (1): Preparation of PP Homopolymer

3.5 L anhydrous hexane was added to a 10 L polymerization reaction vessel; 36 g styrene, 0.81 g triethylaluminum (TEA) and 0.05 g hybrid catalyst B were added at 30° C. Propylene gas was added to keep the pressure inside the vessel at 10 atm. The temperature was increased to 70° C.; the reaction time was 120 min. The amount of polypropylene obtained was 300 g.

(2): Copolymerization of Ethylene /1-octene

Residual propylene in the reaction vessel of step 1 of this Example was evacuated, and the temperature was decreased to 30° C., 100 g ethylene and 100 g 1-octene were added, and the temperature was increased to 85° C. The reaction was maintained for 90 min to obtain 387 g of product finally. The structure and properties of the product from this Example are shown in Table 2 below.

### Example 17

### Preparation of Polyolefin Alloy

### (1): Preparation of PP Homopolymer

3.5 L anhydrous hexane was added to a 10 L polymerization reaction vessel; 36 g styrene, 0.81 g triethylaluminum (TEA) and 0.05 g hybrid catalyst B were added at 30° C. Propylene gas was added to keep the pressure inside the vessel at 10 atm. The temperature was increased to 70° C.; the reaction time was 120 min. The amount of polypropylene obtained was 300 g.

(2): Copolymerization of Ethylene /1-octene

Residual propylene in the reaction vessel of step 1 of this Example was evacuated, and the temperature was decreased to 30° C., 100 g ethylene, 100 g 1-octene and 0.50 g methyl aluminoxane (MAO) were added, and the temperature was increased to 85° C. The reaction was maintained for 90 min to obtain 412 g of product finally. The structure and properties of the product from this Example are shown in Table 2 below.

TABLE 1
Characteristics of the polyolefin alloys of Examples 4-12

| | | Example | | | | | | | | |
|---|---|---|---|---|---|---|---|---|---|---|
| | | 4 | 5 | 6 | 7 | 8 | 9 | 10 | 11 | 12 |
| EOR | % by | 14.0 | 14.3 | 15.8 | 20.2 | 20.9 | 15.5 | 28.6 | 45.5 | 32.7 |
| | weight | | | | | | | | | |
| M.p. | ° C. | 165 | 163 | 163 | 162 | 163 | 164 | 163 | 163 | 163 |
| DSC^{a} | | | | | | | | | | |
| M.p. | ° C. | 118 | 116 | 107 | 106 | 109 | 112 | 107 | 105 | 107 |
| DSC^{b} | | | | | | | | | | |
| Melt | g/10 min. | 59.5 | 27.2 | 24.4 | 7.98 | 7.39 | 7.18 | 4.32 | 0.403 | 2.57 |
| index | | | | | | | | | | |
| Impact | J/m | 29.1 | 35.5 | 42.8 | 52.0 | 88.4 | 78.7 | 85.5 | 159 | 131 |
| strength | | | | | | | | | | |
| at −30° C. | | | | | | | | | | |
| Flexural | MPa | 1059 | 989.4 | 923.6 | 887.0 | 1026 | 992.5 | 840.2 | 689.3 | 799.2 |
| modulus | | | | | | | | | | |

TABLE 2
Characteristics of the polyolefin alloys of Examples 13-17

| | | Example | | | | |
|---|---|---|---|---|---|---|
| | | 13 | 14 | 15 | 16 | 17 |
| EOR^{c} | % by | 10.7 | 15.9 | 8.8 | 22.5 | 27.2 |
| | weight | | | | | |
| M.p. DSC^{a} | ° C. | 163 | 163 | 163 | 162 | 162 |
| M.p. DSC^{b} | ° C. | 92.6 | 88.8 | 84.3 | — | — |
| Melt index | g/10 min. | 5.67 | 4.12 | 8.52 | 3.29 | 3.04 |
| Impact | J/m | 114 | 148 | 127 | 229 | 251 |
| strength at | | | | | | |
| −30° C. | | | | | | |
| Flexural | MPa | 1124 | 1209 | 1278 | 1002 | 988 |
| modulus | | | | | | |

^{a},^{b}M.p. DSC. correspond to melting-point of PP and melting-point of long-segment part of the semi-crystalline in the copolymer rubber phase respectively.
EOR: a copolymer of ethylene/α-olefins formed in stage 2

What is claimed is:

1. A process for the preparation of polyolefin alloy, comprising the steps of:
(a) adding hybrid catalyst, one or more olefin monomers, and a catalyst inactivator into a reactor; allowing a first polymerization reaction to occur either as a slurry polymerization in an alkane solvent having about 5 to 10 carbon atoms or in an aromatic solvent, or alternatively to occur as a bulk polymerization directly in the olefin monomers, wherein temperature for the first polymerization reaction is in the range of about 0° C. to 80° C.;
and further wherein the structure of the catalyst inactivator is CH₂═CH—B, wherein B is selected from the group consisting of phenyl, biphenyl, naphthyl, anthracenyl, unsubstituted phenanthrenyl and phenanthrenyl substituted with alkyl or alkoxyl and wherein the inactivator is used in an amount of about 0. 1% to 20% based on the total weight of olefin monomers in the reactor; and,
(b) stopping the addition of olefin monomers after the substantial completion of the first polymerization reaction, then adding olefin monomers and activators needed to initiate a second polymerization reaction, wherein the temperature for the second polymerization reaction is in the range of about 60° C. to 120° C.; and further wherein the olefin monomers used in the first polymerization reaction and in the second polymerization reaction are selected from one or more olefins having about 2 to 12 carbon atoms, dienes, cyclic olefins and norbornene.

2. The process for preparation of polyolefin alloy according to claim 1, wherein the activator is ethylene in an amount of more than 1% based on the total weight of the hybrid catalyst.

3. The process for preparation of polyolefin alloy according to claim 1, wherein the hybrid catalyst is a catalyst mixture consisting essentially of Ziegler-Natta catalyzing component and metallocene catalyzing component, by weight percentage, wherein said mixture includes:
(a) a first compound having a transition metal Ml selected from titanium and vanadium without containing any M^{I}-π bonds, wherein the transition metal M^{I} is present in an amount of about 0.1% to 20%;
(b) a second compound having a transition metal M selected from Ti, Zr, V or Hf containing at least one M-π bond, wherein the transition metal M is present in an amount of about 0.05% to 2%;
(c) magnesium halide, wherein the metal magnesium is present in an amount of about 5% to 20%;
(d) aluminoxane, wherein the metal Al is present in an amount of about 0.1% to 20%; and
(e) an internal electron-donor in an amount of about 1% to 30%.

4. The process for preparation of polyolefin alloy according to claim 3, wherein the first compound in the hybrid catalyst is selected from the group consisting of halides of Ti, halo-alcoholates of Ti, VCl₃, VCl_{4,} VOCl₃ and halo-alcoholates of V.

5. The process for preparation of polyolefin alloy according to claim 4, wherein the first compound is a halide of Ti selected from the group consisting of TiCl₄, TiCl₃ and halo-alcoholates of the general chemical formula Ti(OR^{I})ₘXₙ, in which R^{I} represents an alkyl group or alkoxy group with 1 to about 12 carbon atoms, X represents a halogen, m, and n=0˜4, and (m+n) represents the valency of the Ti.

6. The process for preparation of polyolefin alloy according to claim 3, wherein the magnesium halide in the hybrid catalyst is MgCl₂.

7. The process for preparation of polyolefin alloy according to claim 3, wherein in the hybrid catalyst, aluminoxane is a linear or non-linear compound having 1 to about 50 repeating units of the moiety —(R₄)AlO—, wherein R₄ represents alkyl or cycloalkyl having 1 to about 12 carbon atoms, or aryl having about 6 to 10 carbon atoms.

8. The process for preparation of polyolefin alloy according to claim 7, wherein the aluminoxane is methyl aluminoxane.

9. The process for preparation of polyolefin alloy according to claim 3, wherein in the hybrid catalyst, the internal electron-donor is selected from the group consisting of mono-esters, di-esters and diethers.

10. The process for preparation of polyolefin alloy according to claim 3, wherein in the hybrid catalyst, the internal electron-donor is selected from the group consisting of diethyl succinate, dibutyl adipate, diethyl phthalate, diisobutyl phthalate, 2,2-diisobutyl-1,3-dimethoxypropane and 9,9-bis(methoxymethyl) fluorine.

11. The process for preparation of polyolefin alloy according to claim 3, wherein in the hybrid catalyst, the second compound is a compound obtained from one or more ligands each having a mono- or polycyclic structure containing conjugated a electrons coordinating with metal M.

12. The process for preparation of polyolefin alloy according to claim 11, wherein the second compound has a general chemical formula selected from the group consisting of:
Cp^{I}MR¹ₐR²_{b}R³_{c} (I)
or
Cp^{I}Cp^{II}MR¹ₐR²_{b} (II)
or
(Cp¹-A_{c}-Cp^{II})MR¹ₐR²_{b} (III)
in which M represents Ti, V, Zr or Hf, Cp^{I} and Cp^{II}, which may be the same or different, represent cyclopentadienyl groups or substituted cyclopentadienyl groups; R¹, R² and R³, which may be the same or different, represent atoms of hydrogen, halogen, an alkyl or alkoxy group with 1 to about 20 carbon atoms, aryl or substituted aryl with about 6-20 carbon atoms, an acyloxy group with 1 to about 20 carbon atoms, an allyl group, or a substituent containing a silicon atom; A represents an alkyl bridge or one with a structure selected from: 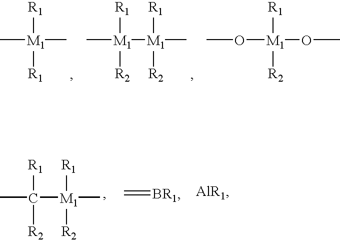
—Ge—, —Sn—, —O—, —S—, ═SO, ═SO₂, ═NR₁, ═PR₁, ═P(O)R₁, in which M₁ represents Si, Ge, or Sn; R₁ and R₂, which may be the same or different, represent alkyl groups with 1 to about 4 carbon atoms or aryl groups with about 6-10 carbon atoms; a, b and c represent, independently, integers of from 0 to 4; and e represents an integer of from 1 to 6.

13. The process for preparation of polyolefin alloy according to claim 12, wherein the second compound is a compound having the structure (I) which is selected from the group consisting of (Me₅Cp)MMe₃, (Me₅Cp)M(OMe)₃, (Me₅Cp)MCl₃, (Cp)MCl₃, (Cp)MMe₃, (MeCp)MMe₃, (Me₃Cp)MMe₃, (Me₄Cp)MCl₃, (Ind)MBenz₃, (H₄Ind)MBenz₃, and (Cp)MBu₃.

14. The process for preparation of polyolefin alloy according to claim 12, wherein the second compound is a compound having the structure (II) which is selected from the group consisting of (Cp)₂MMe₂, (Cp)₂MPh₂, (Cp)₂MEt₂, (Cp)₂MCl₂, (Cp)₂M(OMe₂, (Cp)₂M(OMe)Cl, (MeCp₂MCl₂, (Me₅Cp)₂MCl₂, (Me₅Cp)₂MMe₂, (Me₅Cp)₂MMeCl, (Cp)(Me₅Cp)MCl₂, (1-MeFlu)₂MCl₂, (BuCp)₂MCl₂, (Me₃Cp)₂MCl₂, (Me₄Cp)₂MCl₂, (Me₅Cp)₂M(OMe)₂, (Me₅Cp)₂M(OH)Cl, (Me₅Cp)₂M(OH)₂, (Me₅Cp)₂M(C₆H₅)₂, (Me₅Cp)₂M(CH₃)Cl, (EtMe₄Cp)MCl₂, [(C₆H₅)Me₄Cp]₂MCl₂, (Et₅Cp)₂MCl₂, (Me₅Cp)₂M(C₆H₅)Cl, (Ind)₂MCl₂, (Ind)₂MMe₂, (H₄Ind)₂MCl₂, (H₄Ind)₂MMe₂{[Si(CH₃)₃]Cp}₂MCl₂, {[Si(CH₃)₃]₂Cp}₂MCl₂, and (Me₄Cp)(Me₆Cp)MCl₂.

15. The process for preparation of polyolefin alloy according to claim 12, wherein the second compound is a compound having the structure (III) which is selected from the group consisting of C₂H₄(Ind)₂MCl₂, C₂H₄(Ind)₂MMe₂, C₂H₄(H₄Ind)₂MCl₂, C₂H₄(H₄Ind)₂MMe₂, Me₂Si(Me₄Cp)₂MCl₂, Me₂Si(Me₄Cp)₂MMe₂, Me₂SiCp₂MCl₂, Me₂SiCp₂MMe₂, Me₂Si(Me₄Cp)₂MMeOMe, Me₂Si(Flu)₂MCl₂, Me₂Si(2-Et-5-iprCp)₂MCl₂, Me₂Si(H₄Ind)₂MCl₂, Me₂Si(H₄Flu)₂MCl₂, Me₂SiCH₂(Ind)₂MCl₂, Me₂Si(2-Me-H₄Ind)₂MCl₂, Me₂Si(2-MeInd)₂MCl₂, Me₂Si(2-Et-5-iPr-Cp)₂MCl₂, Me₂Si(2-Me-5-Et-Cp)₂MCl₂, Me₂Si(2-Me-5-Me-Cp)₂MCl₂, Me₂Si(1-Me-7-benzoindenyl)₂ZrCl₂, Me₂Si(2-Me-4,5-benzoindenyl)₂MCl₂, Me₂Si(4,5-benzoindenyl)₂MCl₂, Me₂Si(2-EtInd)₂MCl₂, Me₂Si(2-iPr-Ind)₂MCl₂, Me₂Si(2-t-butyl-Ind)₂MCl₂, Me₂Si(3-t-butyl-5-MeCp)₂MCl₂, Me₂Si(3-t-butyl-5-MeCp)₂MMe₂, Me₂Si(2-MeInd)₂MCl₂, C₂H₄(2-Me-4,5-benzoindenyl)₂MCl₂, Me₂C(Flu)CpMCl₂, Ph₂Si(Ind)₂MCl₂, Ph(Me)Si(Ind)₂MCl₂, C₂H₄(H₄Ind)M(NMe₂)OMe, isopropylidene-(3-t-butyl-Cp)(Flu)MCl₂, Me₂C(Me₄Cp)(MeCp)MCl₂, MeSi(Ind)₂MCl₂, Me₂Si(Ind)₂MMe₂, Me₂Si(Me₄Cp)₂MCl(OEt), C₂H₄(Ind)₂M(NMe₂)₂, C₂H₄(Me₄Cp)₂MCl₂, C₂H₄(Ind)₂MCl₂, Me₂Si(3-Me-Ind)₂MCl₂, C₂H₄(2-Me-Ind)₂MCl₂, C₂H₄(3-Me-Ind)₂MCl₂, C₂H₄(4,7-Me-H₄Ind)₂MCl₂, C₂H₄(5,6-Me₂-Ind)₂MCl₂, C₂H₄(2,4,7-Me₃-Ind)₂MCl₂, C₂H₄(3,4,7-Me₃-Ind)₂MCl₂, C₂H₄(2-Me-H₄Ind)₂MCl₂, C₂H₄(4,7-Me₂-H₄Ind)₂MCl₂, C₂H₄(2,4,7-Me₃-H₄Ind)₂MCl₂, Me₂Si(4,7-Me₂-Ind)₂MCl₂, Me₂Si(5,6-Me₂-Ind)₂MCl₂, and Me₂Si(2,4,7-Me₃-H₄Ind)₂MCl₂.

16. The process for preparation of polyolefin alloy according to claim 1, wherein the catalyst inactivator is used in an amount of about 0.5% to 2% based on the total weight of olefins monomers in the reactor.

17. The process for preparation of polyolefin alloy according to claim 16, wherein the temperature for the first polymerization reaction is in the range of about 40° C. to 75° C., and the temperature for the second polymerization reaction is in the range of about 75° C. to 95° C.

18. The process for preparation of polyolefin alloy according to claim 17, wherein alkyl aluminum is further added as a co-catalyst in the first polymerization reaction in an amount such that the weight ratio of Al/Ti equals about 1˜1000.

19. The process for preparation of polyolefin alloy according to claim 18, wherein alkyl aluminum is added in an amount such that the weight ratio of Al/Ti equals about 50˜200.

20. The process for preparation of polyolefin alloy according to claim 18, wherein the alkyl aluminum is trialkyl aluminum, or mixtures of trialkyl aluminum with halogenated or multi halogenated alkyl aluminum.

21. The process for preparation of polyolefin alloy according to claim 1, wherein an external electron-donor is further added in the first polymerization reaction in an amount of greater than 0 to about 100 times by mole relative to the element Ti in the hybrid catalyst.

22. The process for preparation of polyolefin alloy according to claim 21, wherein the external electron-donor is selected from the group consisting of mono-esters, di-esters and diethers.

23. The process for preparation of polyolefin alloy according to claim 21, wherein the internal electron-donor in the hybrid catalyst is a carboxylate, and the external electron-donor is a organosilicon compound having an Si—O group of the formula R₁R₂Si(OR)₂ in which R₁ and R₂ independently are selected from alkyl, cycloalkyl, and aryl groups with from 1 to about 18 carbon atoms, and R is an alkyl radical with from 1 to about 5 carbon atoms.

24. A process for preparation of polyolefins alloy according to claim 3, comprising the steps of:
charging spherical MgCl₂ carrier and alcohol having about 2 to 4 carbon atoms in a molar ratio to MgCl₂ of about 1:1 to 4:1 into a preparing bottle under a temperature of about −20° C. to 10° C., and incorporating the first compound having a transition metal M^{I} selected from titanium and vanadium without containing M^{I}-π bonds, wherein the transition metal M^{I} is present in an amount of about 0.1% to 20% by 5 ml to 50 ml per gram of carrier;
stirring and increasing the temperature gradually, incorporating the internal electron-donor when the temperature reaches about 50° C.˜90° C.; then increasing the temperature to about 100° C.˜150° C., stirring and filtering, then incorporating 5 ml to 50 ml of additional first compound, stirring and filtering at about 100° C.˜150° C.; and, mixing a mixed solution of the aluminoxane and the second compound fully stirred at about −25° C. to 25° C. with a spherical Ziegler-Natta catalyzing component, wherein every gram of Ziegler-Natta catalyzing component corresponds to about 1×10⁻⁶mol to 5.6×10⁻⁴ mol of the second compound, at a temperature for mixing in the range of about 0° C. to 80° C., then washing with an alkane having about 5 to 10 carbon atoms or with aromatic solvents, and drying to obtain the hybrid catalyst.

25. The process for preparation of polyolefin alloy according to claim 24, wherein the spherical Ziegler-Natta catalyst is prepared by charging spherical MgCl₂ carrier and alcohol having about 2 to 4 carbon atoms in a molar ratio to MgCl₂ of about 1:1 to 4:1 into a preparing bottle under a temperature of about −20° C. to 0° C., and incorporating the first compound in an amount of about 10 ml to 50 ml per gram of carrier; incorporating the internal electron-donor when the temperature reaches about 50° C.˜90° C.; then increasing the temperature to about 100° C.˜150° C., further incorporating 5 ml to 50 ml of the first compound, stirring at about 100° C.˜150° C. and filtering.

26. The process for preparation of polyolefin alloy according to claim 24, wherein every gram of Ziegler-Natta catalyzing component corresponds to about 2×10⁻⁵ mol to 1.0×10⁻⁴ mol of the second compound.
